(19) United States
(12) Patent Application Publication
(10) Pub. No.: US 2010/0243181 A1
(43) Pub. Date: Sep. 30, 2010

(54) Vented shower curtain

(76) Inventor: Patrick J. O'Connor, Lorton, VA (US)

Correspondence Address: LITMAN LAW OFFICES, LTD., POST OFFICE BOX 15035, CRYSTAL CITY STATION, ARLINGTON, VA, 22215, US

(21) Appl. No.: 12/385,162

(22) Filed: Mar. 31, 2009

(51) Int. Cl. A47K 3/38; B32B 37/12

(52) U.S. Cl. 160/236; 156/157

(57) ABSTRACT

The vented shower curtain is a shower curtain having a plurality of air flow vents formed therethrough, allowing environmental air from outside a shower stall to pass into the shower stall, thus replacing heated air that has escaped overhead from the shower stall, and preventing the shower curtain from curling into the shower stall when a user is showering. The vented shower curtain includes at least two panels, with each panel having opposed first and second edges. The second edge of a first panel overlaps the first edge of a second panel, with a plurality of spaced apart seals securing the second edge of the first panel to the first edge of the second panel. Adjacent ones of the plurality of seals define air vents therebetween, thus allowing environmental to pass through the air vents when the bather is showering.

### BACKGROUND OF THE INVENTION

1. Field of the Invention

The present invention relates to bathroom furnishings, and particularly to a vented shower curtain that allows air to pass through the curtain when a bather is taking a heated shower, thus preventing the shower curtain from curling into the shower stall when the bather is showering.

2. Description of the Related Art

Conventional hanging shower curtains often entangle themselves around bathers when the bathers take relatively hot showers. Typically, the rush of water and temperature differential from the shower creates substantial air currents in and around the shower enclosure. This is especially true of hot water showers, which create substantial updrafts. With a conventional hanging shower curtain, such air currents are sufficient to dislodge the edge of the shower curtain from the wall of the shower enclosure or from the edge of the tub. The pressure differential on either side of the shower curtain is a primary reason the shower curtain billows into the stall. Even though it is warmer inside the stall, heated air currents leave the stall, creating the lower pressure inside the stall. The higher pressure and cooler air outside is what pushes the curtain into the stall.

Secondly, turbulent airflow is generated when water moves through the air. The stronger the jet of water, the more turbulent the air flow. This even happens during the summer with a strong jet of colder water causing turbulent airflow. This is why a soft flow of water or mist does not cause substantial billowing while a stronger jet does. If the curtain pulls away from the wall, water can escape. If the curtain pulls away from the tub, it can interfere with the person taking the shower and water can splash out of the tub. In the past, magnets, formed into the hem of the shower curtain, have been used to form a seal between the curtain and the tub.

However, few modern bathtubs are formed from paramagnetic ceramics. Many other shower curtain designs have been attempted in order to alleviate this problem, but as with the magnetic seals, they either do not work with conventional, modern shower stalls or bathtubs, or require the installation of custom shower curtain rods, or customized shower enclosures.

Thus, a vented shower curtain solving the aforementioned problems is desired.

### SUMMARY OF THE INVENTION

The vented shower curtain is a shower curtain having a plurality of air flow vents formed therethrough, allowing environmental air to flow therethrough, into a shower stall, thus preventing the shower curtain from curling into the shower stall when a user is showering. The air flow vents may be oriented in any suitable direction, or may be formed in any suitable geometric pattern. The vented shower curtain includes multiple panels. In a first exemplary embodiment, a pair of panels are provided, in the form of first and second panels, each having laterally opposed first and second side edges. Each panel preferably is substantially rectangular and is formed from a flexible, waterproof material, such as vinyl or the like, as is conventionally known in the art of shower curtains. Preferably, the first and second panels have approximately equal dimensions.

The second side edge of the first panel overlaps the first side edge of the second panel, preferably with approximately one inch of overlap, with a plurality of spaced apart seals securing the second side edge of the first panel to the first side edge of the second panel. Adjacent ones of the plurality of seals define air vents therebetween, thus allowing the environmental air to pass through the air vents.

Preferably, the second edge of the first panel is heat sealed to the first edge of the second panel. The orientation of the air vents defined by the heat seals may be either substantially horizontal or vertical.

These and other features of the present invention will become readily apparent upon further review of the following specification and drawings.

### BRIEF DESCRIPTION OF THE DRAWINGS

FIG. 1 is an environmental, perspective view of a vented shower curtain according to the present invention.

FIG. 2 is a front view of the vented shower curtain according to the present invention.

FIG. 3 is an exploded perspective view of the vented shower curtain according to the present invention.

FIG. 4 is a front view of an alternative embodiment of the vented shower curtain.

Similar reference characters denote corresponding features consistently throughout the attached drawings.

### DETAILED DESCRIPTION OF THE PREFERRED EMBODIMENTS

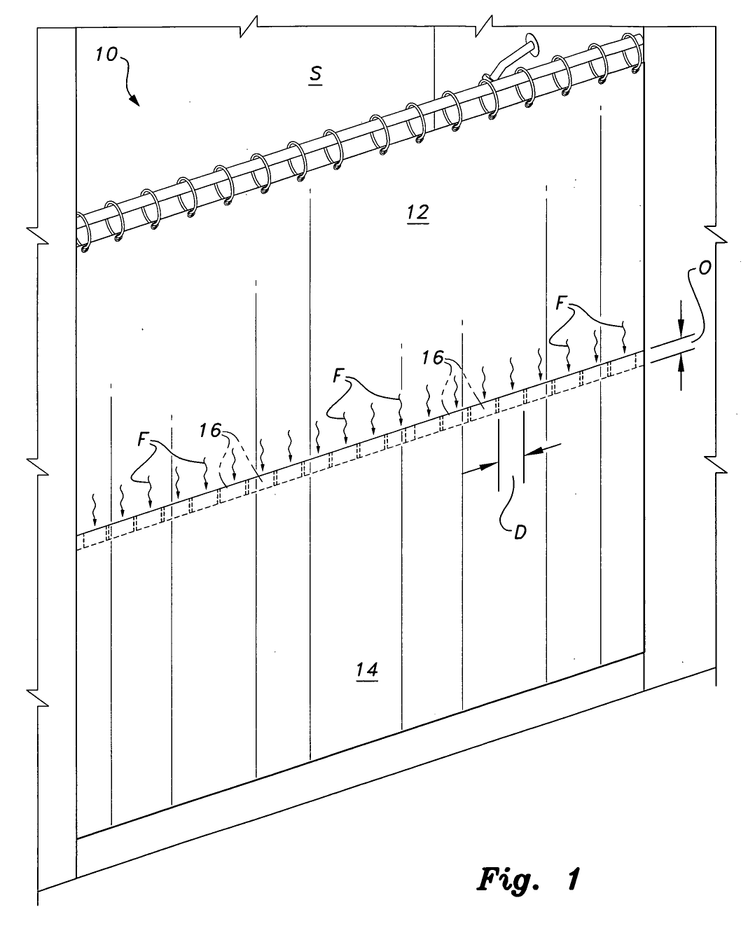

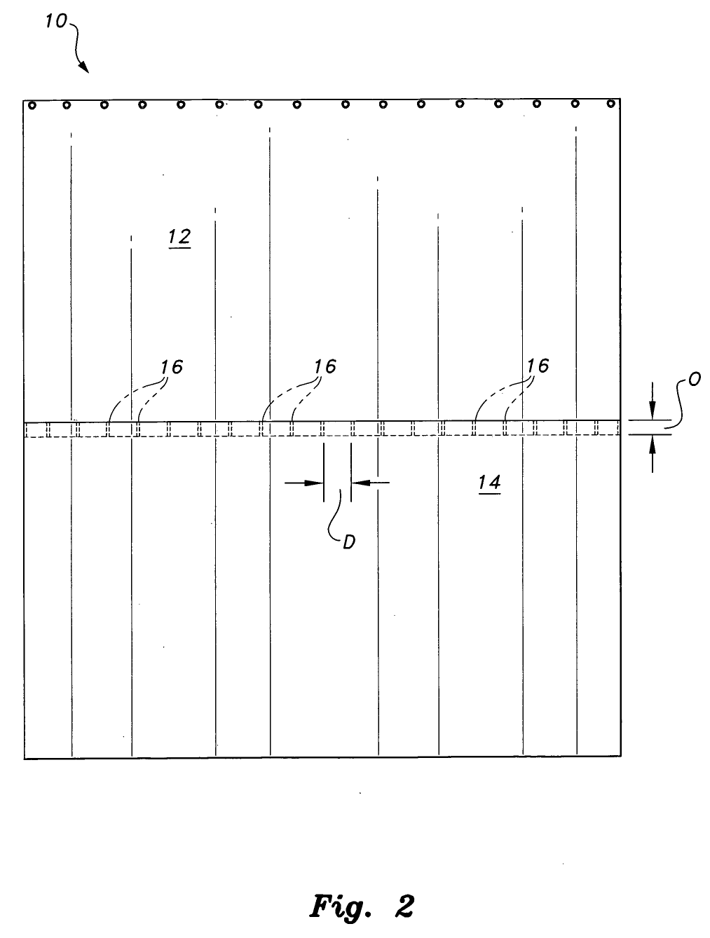

Now referring to FIGS. 1 and 2, the vented shower curtain 10 is a shower curtain having a plurality of air flow vents formed therethrough, allowing environmental air to flow into a shower stall S, thus preventing the shower curtain 10 from curling into the shower stall S when the user is showering. As noted above, the pressure differential on either side of the shower curtain is a primary reason the shower curtain billows into the stall. Even though it is warmer inside the stall, heated air currents leave the stall, creating the lower pressure inside the stall. The higher pressure and cooler air outside is what pushes the curtain into the stall. Secondly, turbulent airflow is generated when water moves through the air. The stronger the jet of water, the more turbulent the air flow. This even happens during the summer with a strong jet of colder water causing turbulent airflow. This is why a soft flow of water or mist does not cause substantial billowing while a stronger jet does. The cooler, environmental air flowing through the vents of the shower curtain 10 is shown by directional arrows F in FIG. 1. This airflow is generated by the pressure differential between the relatively high pressure of the cooler, external air and the relatively lower pressure of the heated, upwardly flowing and turbulent air within the shower stall. It should be understood that shower stall S is shown for exemplary purposes only.

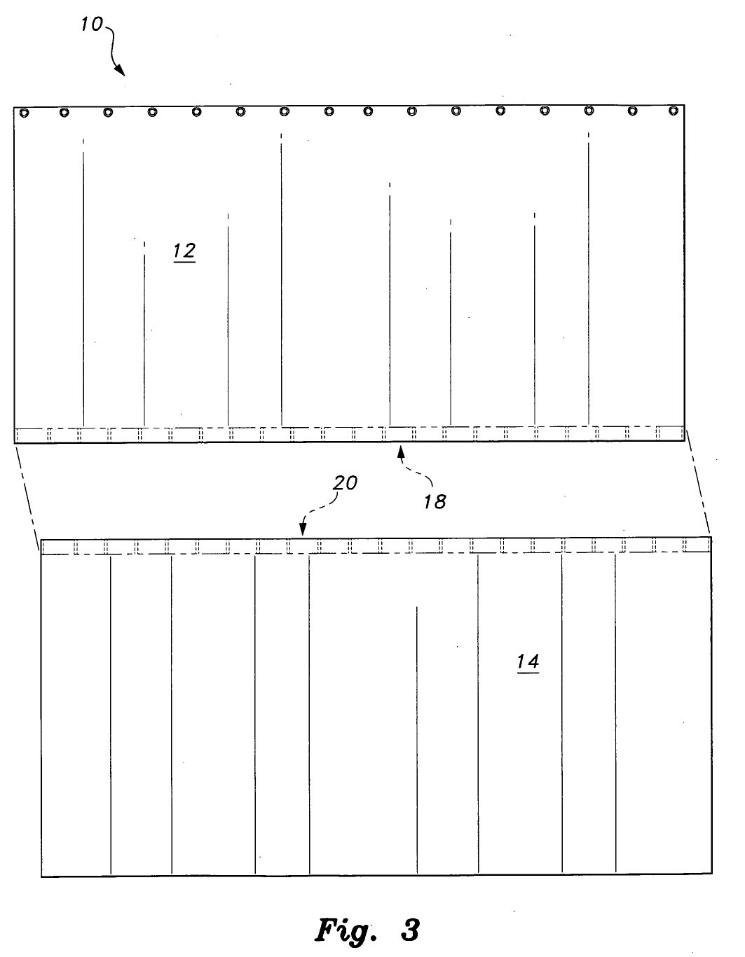

The vented shower curtain includes a plurality of panels. In the exemplary embodiment illustrated in FIGS. 1-3, a pair of panels are provided. It should be understood that more than two panels may be utilized, and that FIGS. 1-3 illustrate an exemplary configuration only. As best shown in FIGS. 2 and 3, the exemplary vented shower curtain 10 includes first and second panels 12, 14, respectively, each having longitudinally opposed first and second edges. Each panel preferably is substantially rectangular and is formed from a flexible, waterproof material, such as vinyl or the like, as is conventionally known in the art of shower curtains. Although the dimension and configuration of vented shower curtain 10 may be varied, vented shower curtain 10 is preferably substantially rectangular, and has dimensions similar to those of a conventional shower curtain. The panels preferably have approximately equal dimensions. Conventional shower curtains typically have a length of approximately seventy-two inches, and a height of approximately seventy inches. It should be understood that the venting of vented shower curtain 10 may be applied to a shower curtain having any desired dimensions and, as noted above, more than two panels may be provided, with vents being formed between adjacent ones of the multiple panels.

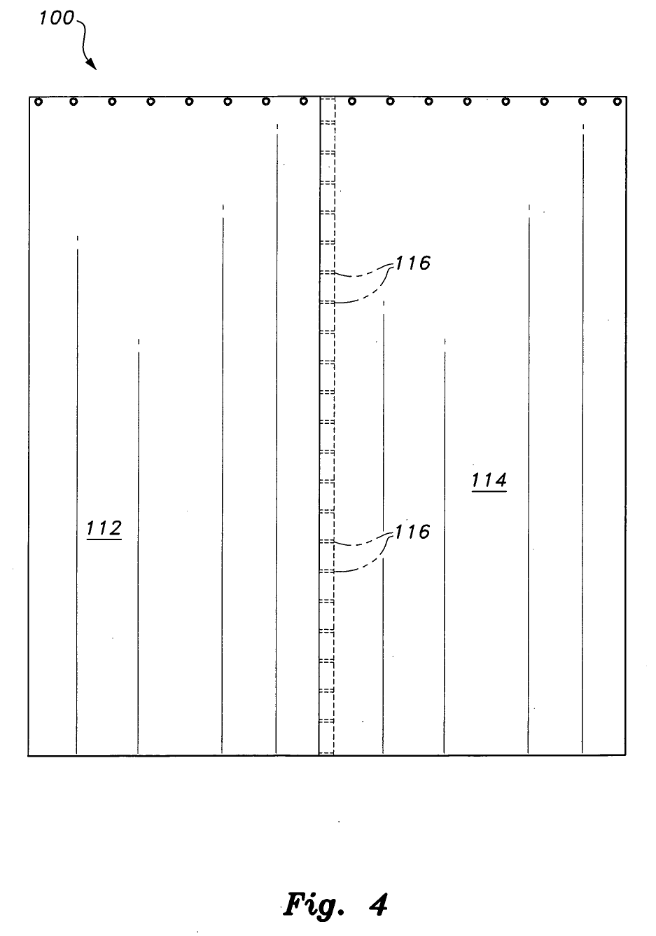

As best shown in FIG. 3, the second edge 18 (the lower edge in the configuration illustrated in FIG. 3) of first panel 12 overlaps the first edge 20 (the upper edge in FIG. 3) of the second panel 14, preferably with approximately one inch of overlap. In FIG. 2, the overlapping region is shown generally as having a width O, which, as noted above, is preferably approximately one inch, although it should be understood that the width may be varied, depending upon the overall desired dimensions of shower curtain 10. As will be described in detail below, a plurality of air flow vents are formed between panels 12 and 14. The overlapping region formed by the overlap of edges 18, 20 prevents water from escaping through the vents when the user is showering. As described above, airflow occurs from the cooler, external air, to the warmer interior of the shower stall. Thus, the overlap of panels, from the higher panel to the lower panel, is formed on the stall, or interior, side of the shower curtain, allowing the airflow to pass through the curtain 10 while, at the same time, preventing water leakage. In the embodiment of FIG. 4, to be described in detail below, the overlap is formed from the shower head end of the curtain to the opposite end thereof.

A plurality of spaced apart seals 16 secure the second edge 18 of first panel 12 to the first edge 20 of the second panel 14. Seals 16 may be any suitable form of waterproof seals, such as waterproof adhesive or tape, for example, but are preferably formed as heat seals. Adjacent ones of the plurality of seals 16 define the air vents therebetween, thus allowing the environmental air to flow into the shower stall S covered by the vented shower curtain 10 when the user is taking a heated shower (shown by directional air flow arrows F in FIG. 1).

As noted above, preferably, the second edge 18 of the first panel 12 is heat sealed to the first edge 20 of the second panel 14. The plurality of heat seals 16 may be formed, during manufacture, in any suitable manner. In FIGS. 1-3, the first and second side edges of each of panels 12, 14 are shown oriented in a substantially horizontal direction, thus aligning the plurality of air vents along a substantially horizontal axis. It should be understood that the air vents may be aligned along any suitable axis, and may be formed in any desired number, with any desired spacing. Further, as noted above, the pair of panels shown in the Figures are for exemplary purposes only. The shower curtain 10 may be formed from any suitable number of panels, with vents being formed between adjacent pairs of panels.

When aligned in the horizontal direction shown in FIGS. 1-3, each heat seal 16 is spaced apart from the adjacent heat seals. The distance of spacing may be varied, dependent upon the overall dimensions of the shower curtain 10 and the number, and configuration, of panels utilized. Exemplary dimensions include a spacing between approximately two and three inches. The distance between adjacent heat seals 16 (i.e., the horizontal width of each air vent) is labeled generally in FIG. 2 as distance D.

FIG. 4 illustrates an alternative, exemplary embodiment in which panels 112, 114 of vented shower curtain 100 are sealed together along vertical edges thereof by heat seals 116. Vented shower curtain 100 is similar to vented shower curtain 10 of FIGS. 1-3, except that the air vents formed between panels 112, 114 are aligned in a substantially vertical direction. In this orientation, each heat seal 116 is preferably spaced apart from the adjacent heat seals 116 between approximately three and four inches. This spacing distance is relative the exemplary dimensions given above for FIGS. 1-3. It should be understood that, as described above with regard to shower curtain 10, the spacing may be varied, dependent upon the overall dimensions of the shower curtain 100 and the number, and configuration, of panels utilized.

It is to be understood that the present invention is not limited to the embodiments described above, but encompasses any and all embodiments within the scope of the following claims.

I claim:

1. A vented shower curtain, comprising:
a plurality of panels, each of the panels having opposed first and second edges, the second edge of each of the panels overlapping the first edge of an adjacent one of the panels; and
a plurality of spaced apart seals securing the second edge of each of the panels to the first edge of the adjacent one of the panels, adjacent seals defining air vents therebetween;
whereby, environmental air may pass through the air vents when a bather takes a heated shower.

2. The vented shower curtain as recited in claim 1, wherein said plurality of seals are heat seals.

3. The vented shower curtain as recited in claim 2, wherein the first and second edges of each of said panels extends along a substantially vertical direction.

4. The vented shower curtain as recited in claim 3, wherein the adjacent ones of said plurality of seals are spaced apart from each other between approximately three inches and four inches.

5. The vented shower curtain as recited in claim 2, wherein the first and second edges of each said panel extend along a substantially horizontal direction.

6. The vented shower curtain as recited in claim 5, wherein the adjacent ones of said plurality of seals are spaced apart from each other between approximately two inches and three inches.

7. The vented shower curtain as recited in claim 1, wherein the second side edge of each said panel overlaps the first side edge of the adjacent one of said panels by a width of approximately one inch.

8. A method of forming a vented shower curtain, comprising the steps of:
providing at least two panels, each of the panels having opposed first and second edges;
positioning the second edge of each of the panels over the first edge of an adjacent one of the panels; and
sealing the second edge of each of the panels to the first edge of the adjacent one of the panels so that a plurality of air vents are formed between the overlapping second edge of each of the panels and the first edge of the adjacent panel.

9. The method of forming a vented shower curtain as recited in claim 8, wherein said step of sealing comprises heat sealing the second edge of each said panel to the first edge of the adjacent panel.

10. The method of forming a vented shower curtain as recited in claim 9, further comprising the step of orienting the first and second edges of each said panel along a substantially vertical direction, wherein said step of sealing comprises the formation of a plurality of heat seals.

11. The method of forming a vented shower curtain as recited in claim 10, wherein adjacent ones of said heat seals are spaced apart from each other between approximately three and four inches.

12. The method of forming a vented shower curtain as recited in claim 9, further comprising the step of orienting the first and second edges of each said panel along a substantially horizontal direction, wherein said step of sealing comprises the formation of a plurality of heat seals.

13. The method of forming a vented shower curtain as recited in claim 12, wherein adjacent ones of said heat seals are spaced apart from each other between approximately two and three inches.
